(19) United States
(12) Patent Application Publication
(10) Pub. No.: US 2024/0095212 A1
(43) Pub. Date: Mar. 21, 2024

(54) Smartphone Organization System and Application

(71) Applicant: William Shatner, Hollywood, CA (US)

(72) Inventor: William Shatner, Hollywood, CA (US)

(21) Appl. No.: 17/933,086

(22) Filed: Sep. 17, 2022

(51) Int. Cl. G06F 16/16; G06F 16/13; G06F 16/14

(52) U.S. Cl. CPC G06F 16/16; G06F 16/13; G06F 16/148; H04W 64/003

(57) ABSTRACT

An system which automatically characterizes contents of important files, and saves those important files in a way that they can be easily found later by determining context at the time when the file is requested and matching that to the contents of the files. An embodiment uses global information, so that when one person identifies an unknown file, it is automatically usable for others to identify similar unknown files.

### BACKGROUND

Smartphones are ubiquitous around the world, and have become the primary computing device for many. In the developing world, this is simply a function of cost and required wireless Internet coverage. Billions of people do not have desktop or laptop computers. They transact their business and pleasure on a smartphone.

Curiously, this is also a reality for many Americans. Most work can now be done remotely or on the go. Think of the real estate agents who rarely get into his or her office. They work on their phones as they move about.

In addition to mobile professionals, many senior citizens are dependent on their smartphones, which is often their primary way to communicate with the world. This large senior market also has an inherent problem. Many older people are less capable of understanding software and user interface. They want the phone to do the tasks they want without having to understand the coding or the unique apps that can be mindboggling. They did not grow up with advanced technology like their children or grandchildren.

This is especially true as senior users navigate emails and websites.

Often attachments and files are designed for desktop or laptop computers. Microsoft Office files and Adobe PDFs often open on smartphones but their usability is diminished due to the small screen size and lack of native software installed on the device.

Another challenge with using a smartphone is organization. Desktop and laptop computers have large screens where files, folders and icons can live. It is analogous to a suburban home and its spacious backyard. The real estate on a smartphone is much more crowded—more like an urban high-rise apartment. This necessitates smart design and space planning Unfortunately, this is difficult to do on a smartphone while continuing to use it. Often emails are misplaced, files end up in the wrong spot, or files do not open outside of their original context. With thousands of files or more being stored on a smart phone, there are significant challenges in trying to find the file that a user wants when the user wants it.

Imagine a busy traveling person. While moving about they may get dozens or hundreds of messages, emails, files, and links. Because they are mobile, they do not have time to organize these items. In many email apps, everything seems to be important. The issue is that when everything is important—nothing is important. How can a busy person—especially a senior or someone who is less tech-savy, succesfully navigate through smartphone operating systems.

The proliferation of apps has also been a mixed blessing in the smartphone world. While people love to have an app for everything, it often means scrolling through pages and pages of app icons trying to find what you need. This is painful on a mobile device given the size of the screen. Furthermore, this is even more challenging on a smart watch or other smaller electronic devices.

### SUMMARY OF THE INVENTION

The inventor recognized that a need exists for a system to help address and solve the file organization and management issues on smartphones. An object of the present application is providing a simple way and place to move, store and access files on a portable device by determining when, where and how a stored filed will be used.

An embodiment puts the control for the file request on the home screen of the device, as a virtual place holder, e.g., item kitchen counter where one can place items upon returning home, to form a virtual safe deposit box for items that are valuable and essential and provides a way to access those files, so that the user can easily find the files when needed.

The present invention relates to a method and system for file organization and management on smartphone or tablet devices. In particular, the invention relates to an app that appears simple but does complicated work behind the scenes to ensure ease of use, security, and quick access.

The present application recognizes that many different kinds of information are obtained on the phone, including information that is extremely useful, and information that is not so useful. A challenge is how to organize this information, and how to have the information available when the user actually needs the information.

Another challenge comes from determining the relevance of the information thus stored, especially when large amounts of information are so stored. An embodiment describes a “magic button” that is selected to store information that is automatically characterized. The magic button can be selected to find information that is likely to be relevant to a user's current situation.

### BRIEF DESCRIPTION OF THE DRAWINGS

In the Drawings:

the figures show aspects of the invention, and specifically:

FIG. 1 shows an embodiment of a portable device with a display, and showing a store and retrieve button;

FIG. 2 shows a flowchart of operation of storing an important file and characterizing the file for later retrieval; and

FIG. 3 shows an operation of retrieving an important file using current contacts to retrieve the file.

### DETAILED DESCRIPTION

The present application describes a system for receiving and analyzing files, which according to the present invention, can be virtually anything that is stored or displayed on the phone, including a conventional file of any format, a ticket, an image a description, or any other file that can be stored and/or viewed on a portable device. The present application also describes characterizing the file to provide data that is stored with the file, and using clues in context to determine a likely file that is going to be requested by a user. The present application also describes learning from situations when the program is “dumped” and cannot determine the file contents.

In an embodiment, a file is marked by a user as “important”, meaning that the file will be needed at some future point. The files are marked by pressing the magic button at the time the file is open or otherwise in focus. The marked file is automatically analyzed and indexed.

In an embodiment, the marking of the file can be done using a magic button. The button can be a pop-up, which can appear on any screen, or can be requested using the AI virtual assistant in the portable device such as Siri or Alexa.

The indexing creates a different characterizing data about the file, each item of characterizing data represented by a category. Each of the categories, and the data representing the category is formed into a feature vector that has various categories of information representing the file and information associated with the categories.

The file and its feature vector are then stored.

When a user wants a file, the app automatically determines characteristics of the context at the time when the user asks for the file, and automatically determines one or multiple best matches to the user's request.

The present application is intended to be operated on a portable electronic device such as a portable phone or tablet or other kind of computer. This system can be used in any computing platform, however may show special advantages in a situation like a cell phone where files that are received are typically difficult to name or catalog appropriately.

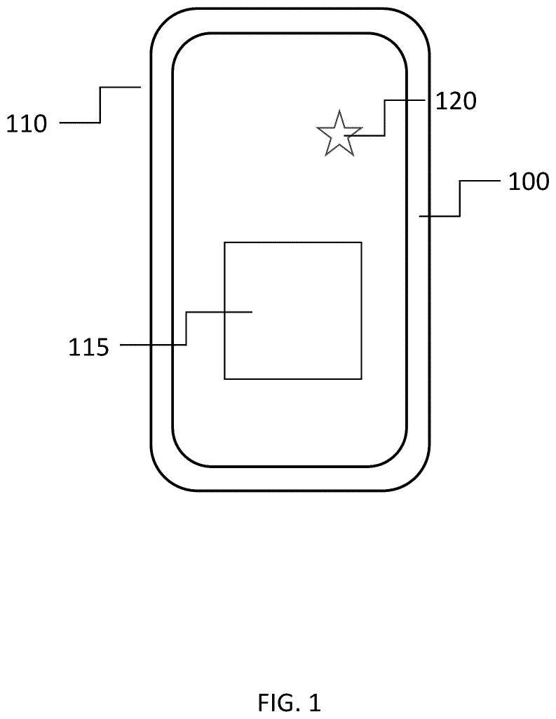

A handheld phone 100 is shown in FIG. 1, receiving data 110 over cellular, wireless and other networks. A received file 115 is shown, along with the button 120. The button 120 can be selected by a user to indicate that the file is “important”. The user selects this button 120 to indicate that the current file is an important file. This starts a sequence of actions which is described herein.

The magic button 120 is shown as being a special icon, however this can also be selected using existing menus that are already in existence on the user's phone, such as an arrow icon or alternatively selected by using the virtual personal assistant such as Siri or Alexa.

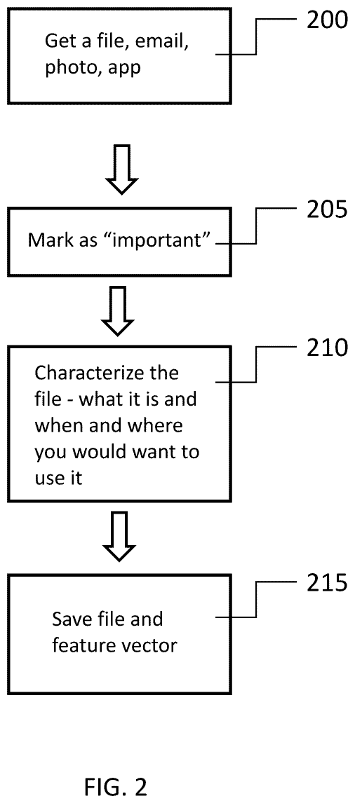

The flowchart of operation shown in FIG. 2. At 200, the user has received the file as shown in FIG. 1, from any of a number of different sources. The file can be an email file, photo, event or airline ticket, screen shot, claim ticket, or other file. The file can be produced from an app, or from any other source.

The user then selects the magic button icon 120 at 205 to mark this file as important.

At 210 the processor characterizes the contents of the file that is being stored. These characterizations may include, for example, what is the file, e.g., its content. Is it a ticket, does it have a date that is supposed to be used. Is it an image, and if so, the image is automatically recognized including object recognition of objects in the image, an optical character recognition of any text within the image, to determine the contents of the image. The contents of the file, are analyzed to determine, where and when would you want to use the file. For example, for a ticket, the date where the ticket is usable can be determined. The file is also characterized based on the date the file was receiving, and the location where the user was when they received the file.

If the user is on the phone with someone else at the time that the file is received or marked, then being on the phone with that person can also be marked as information about the file, and used later as part of the context of the file for example when the user is on the phone with that same person again.

Some of this information may be relevant, some of it may be irrelevant. For example, if the file is received by the user while they happen to be sitting at a restaurant, the location where the user was located when they received the file may be of no importance whatsoever. However, if the file is a return ticket to come to a new or later version of the same kind of event that the user is already located, then the location may be very relevant. If the file is an appointment confirmation, for example, for a doctor made while the user is at the doctor's office, then the location of the file can be very important.

All of this information is arranged into a feature vector. The feature vector includes categories, including all of the information discussed above, location of receiving the file, location of intended use of the file, date of use of the file, recognition of items in the file, and the other features above and described herein. The feature vector may also include inputs from machine-learned context, as described herein. Each category in the feature vector may have data associated with the category, or may be blank. The feature vector thus in summary indicates what the file is likely to be, where and when it would be likely to be used, as well as any other information about the file that can be determined.

As described herein, the term feature vector is intended to refer to a catalog of information with categories, and items associated with the categories. Any form of data can be used and is intended to be encompassed within the term “feature vector”.

The above represents the file having been stored. At some later time, the user may want to retrieve that file.

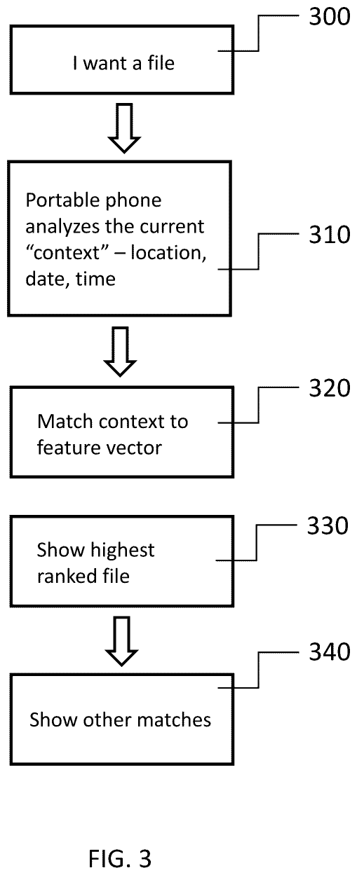

FIG. 3 illustrates a flowchart of retrieving the information. An important feature of retrieving the information is that the system uses its context including its automatic characterization to attempt to find the most likely file for the curren him and t time and location and context.

At 300, the user pushes the “button” to indicate that they want a file.

This is followed at 310 by the device, here portable phone, but in other embodiments other portable devices, analyzing the current context, including the location, time and date, and other context that can be determined by the phone.

At 320, the current context is matched to the files is matched to the feature vectors. The context may be matched using most recent file first, or most relevant feature vector match.

330 returns a file. In one embodiment, this can be the highest ranked file, followed at 340, by other matches if the highest ranked file is not the file desired by the user.

The above has given generalities, which will be made much more specific by examples. Each of these examples are considered to be embodiments of the invention.

In one embodiment, the user receives a plane ticket. The plane ticket is for travel from LAX to Miami on Mar. 1, 2022. The user knows that this is an important document, and hence pushes the magic button to mark the file as important.

The operation then proceeds to characterize this document according to what it is. The document can be a plane ticket, and the plane ticket requires that the user is going to go to LAX airport. The time when the user is going to use it is on Mar. 1, 2022 at a specific time of day.

Now, the user is either in a car, or at the airport itself. The user requests the document at 200, and the context of the operation is determined. The first context is that the time and date are right for the airplane ticket. If the user is at the airport, the categorization may receive the additional context that the user is at an airport, making it very likely that the user will want a plane ticket. This may make it very likely that the plane ticket should be delivered to the user.

The current time and location and other context is compared against the stored feature vectors for the stored files. The plane ticket receives a high score from this comparison and will be the highest ranking document, and hence is displayed for the user.

Moreover, there may be other information that the user needs because they are in an airport. For example the user may need their global entry ID number or government identification. Consequently, after delivering the plane ticket, the highest ranked file shown at 230 if the user wants something other than that highest ranked file, the user can ask to show other matches at 240. These other matches are again based on context.

Thus, the user can have multiple different files returned based on their current context, with the example given above of an airport and the files returned being the airline ticket, identification, frequent flyer numbers, and other such information. This presupposes, of course, that the user has stored their identification using the magic file button, and stored their frequent flyer cards and the like in the same way.

Consider another document example, the user again has a ticket to an event. At the time and/or place of the event, the system will automatically find that the ticket to the event as the highest ranked document.

In another embodiment, the user's takes a picture of something that they later want to follow-up on, then at 210, the system automatically characterizes that picture using its intelligence to figure out what the picture is. In an embodiment, the picture can be a parking ticket, and the system automatically characterizes it as a parking ticket and may provide reminders for the user to pay that parking ticket. If the item is something that the user later wants to follow-up on, the system can automatically follow up on those other items. In one embodiment, the system can follow up on paying the parking ticket when it analyzes that the user has opened a banking app or another kind of paying app to pay other bills. The system can follow up on paying the parking ticket on the date when the parking ticket becomes due or overdue.

In another embodiment, the user obtains an image, e.g. by taking a picture, of the claim check. The claim check may be for example a claim check for drycleaning. Analysis of the picture may find words that indicate that it is a dry cleaner or laundry service, such as “Martin's drycleaning”. In that case, the claim check is stored with information indicating that is from Martin's dry cleaning, and can be easily brought up the next time the user is at Martin's drycleaning. Alternatively, the picture might not say anything about where it's from, or give only subtle hints such as saying “your local cleaner”, or “pick up your cleaning”. The picture will still be indexed as best it can. However, when the user asks for a document, when they are later trying to pick up the dry cleaning, the system might not be able to identify the right document if the system has not gotten a sufficient amount of information from the indexing.

In this latter case, the user needs to get involved and find the right claim check. The system might identify a number of different things that might be a claim check, either from the date range, or by identifying items that system has been unable to properly index. The user, then, identifies which is the right claim check. By doing so, the system obtains an additional item of information, which indicates that at Martin's dry cleaning, the claim check looks like the claim check that was manually identified.

This is used as a piece of machine learning to help the user later identified claim checks for Martin's dry cleaning. In addition, this can be used as global information, so for others other than the user to identify claim checks for Martin's dry cleaning. In this way, once anyone who has access to the global database enters Martin's, the system can automatically identify what a claim check for Martin's looks like. In this way, the system would only be stumped once, and all other times, it would know how to find a Martin's claim check.

In a similar way, this can be used to e.g. claim checks for a valet. When the user is ready for their car, they can push the magic button, which may bring up the valet check as the highest rated item, based on the location and time.

The system can optically character recognize words on a note. A user can take a photo of a note, e.g., a sheet of paper with words written on it. This can be a persons number or address, or can represent anything. It can be a place that the user wants to visit such as a restaurant. After taking a photo of the image, the user presses the magic button, causing the note to be optically character recognize, and information about the note to be stored, including the content of the note and the time when the note was obtained in the place when the note was obtained.

In another embodiment, the user can use a link, for example reviewing a YouTube video on the phone, and selecting the button to indicate that the YouTube video is important. The app can then characterize and remember the YouTube video. If the user is on the phone with someone during a time that the video is viewed, the app would remember the link to the YouTube video and the context of the selection. In this case, it would remember who the person was talking to on the phone.

The app also organizes this data in the background using known identifiers such as website addresses, contact information and time and place. This important record would then be discoverable with advanced search techniques. These search techniques would be intuitive and easy for people to access. In the above-described case, the user could simply select the icon and query what YouTube video was he/she watching when he/she talked with John yesterday? The app would immediately prompt the user with the link or opened video.

The app would also work with other apps so that everything could open in one place. So, instead of opening Abobe Acrobat, the app could simply open the PDF immediately so that the user has the information they need—even without the full functionality of the parent software.

In essence, the app would be a one-stop-shop for things a mobile user flags as important. It this way the app is akin to a personal assistant or butler who helps keep track of essential things for their busy employer.

The app may organize in real-time, or can do so periodically, for example at the end of each day, the proposed app would further organize the flagged items based on various factors such as time, place, person, and relationship to other flagged items. This could happen with keyword analysis and various machine learning processes. Furthermore, it is anticipated that the app could employ Artificial Intelligence (AI) to recognize patterns and user requests. This would allow the app the chance to anticipate requests and provide the best information as soon as possible.

It is further proposed that the current app would be linked to the Cloud. It could immediately store and back-up the information in real-time. This could then be linked other smartphones, computers or devices. In this way, the information is always close at hand. It can also use cloud processing techniques to carry out advanced processing of the information that might be more difficult to do in the phone.

The app would also have the potential to link with voice command software and their famous personas such as Siri, Google and Alexa.

The app can be designed to have constant priority on the home screen. It would be placed on the screen of the smartphone and visible while any other app is running Even when on the phone, an icon for this app would be visible for the user.

The app could also serve as a repository for important files. After reading an important email with an attachment, the app could be selected, and this email and attachment would be saved for access in the future in that location.

In another embodiment, files that are important can be automatically determined by the system, so that the user need not mark those files is important. Embodiments include, for example, things like tickets that will automatically be recognized by the system is important and automatically characterized and stored as an important file and other files described above. In this case, the indication that the file is an important file is automatically determined by the system itself, rather than being received from the user.

The data and information is obtained, managed and displayed in a special format as described herein, which, as programmed, renders this a special-purpose computer carrying out special functions as described herein. These functions cannot be carried out by a general purpose computer without modifying that computer using the techniques of the present disclosure.

The proposed system would make smartphones great again. The system facilitates an app that would be a place where important things could be placed and accessed. It would be one touch or one command away during the use of any program on the phone. It would also be a place to store things that will be needed again—especially those items that were judged to be important but not urgent in the moment.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A programmed system for operating on a portable computing device, comprising:
a portable computing device having a processor, memory, and display, the memory storing plural files on the computing device, and the processor programmed to receive an indication from a user of the portable computing device, that a current file is an important file among the plural files that are stored on the computing device;
the processor operating to characterize the current file according to information about the current file, including characterized information that is determined by the processor to represent contents of the current file;
the processor operating to indicate the current file is an important file, and to store the characterized information about the important file;
wherein there are multiple stored important files,
the processor operating to receive an indication from a user that they want an important file,
the processor automatically determining a current context of the portable computing device, the current context including a location of the computing device,
and the processor using the current context to search the information about the important files that are stored, and to find at least one match between the current context of the computing device and the characterized information about the stored important files, where the at least one match is returned to the user as the important file,
wherein the processor accesses a global database of information related to contents of files that have been characterized by at least one person other than the user when the at least one person other than the user was at a specified location,
and where the processor determines the user at the specified location, and uses a file that was characterized by the at least one person other than the at least one person was at the specified location, to determine the at least one match by finding a file that matches the file that has been characterized by the people other than the user at the specified location.

2. The system as in claim 1, wherein the characterized information about the file is a feature vector having multiple categories of information and having information associated with the categories of the information.

3. The system as in claim 1, wherein the characterizing of the current file comprises characterizing a content of the file, and determining from the characterizing the file, a time when the file would be used, and where the current context includes a time, which is matched to the time when the file would be used.

4. The system as in claim 3, wherein the context of the portable computing device includes a location of the computing device, and a time when the file is requested, and where the time when the file is requested is compared with the characterized information about the file.

5. The system as in claim 1, wherein the characterizing of the file comprises a person who the user was speaking to on a telephone call at a time when the file was received.

6. The system as in claim 1, wherein the file represents a ticket for transportation, the characterizing comprises determining the file is a ticket for transportation, a date of the transportation, and a location where the transportation is initiated.

7. The system as in claim 6, wherein the user requesting an important file at a time for transportation receives a match to the ticket for the transportation.

8. The system as in claim 6, wherein the user requesting an important file at a location of where the transportation is initiated receives a match to the file based on the location.

9. The system as in claim 6, wherein the user also receives other stored files related to the transportation, other than the file representing the ticket.

10. The system as in claim 1 wherein the file represents a ticket to an event, the characterizing comprises determining a time of the event, where the context at the time when the important file is requested includes a current time as a time of the event, and where the ticket is returned as the important file.

11. The system as in claim 1, wherein the file represents an image, and the system automatically characterizes the content of the image to determine uses for the image.

12. The system as in claim 4, where the file represents a link, and the characterizing comprises determining that the user is on a telephone call with a person that was on the call when the user stored the link.

13. (canceled)

14. The system as in claim 1, wherein the processor receives information from the user about the file to be used at one of the specified locations, and stores the file as a first file, along with the specified location as global information to be provided to others, and where the first file is later provided to other users at the specified location, and is used by the people other than the user at the specified location to find a file that matches the first file.

15. A method of operating a file system on a portable computing device, comprising:
receiving a file on the portable computing device;
receiving an indication from a user of the portable computing device that the file is to be used later, and responsive to receiving said indication, characterizing the file according to characterized information about the file; and storing the file along with the characterized information about the file as a stored file;
receiving global information from other at least one other user, each global information indicating a specified file that was used by the at least one other user when the at least one other user was at a specified location;
determining that the user is at the specified location,
responsive to the determining that the user is at the specified location, using the global information obtained from the at least one other user to find one of the stored files that matches to the specified file that was used at the specified location by another user; and
returning the one stored file to the user responsive to the user being at the specified location and using the global information.

16. The method as in claim 15, wherein the file represents a claim check, for a business operating at a location, the global information represents at least one claim check that was stored by and used by another at the location, and the determining comprises finding a stored file which matches the claim check which was stored by another.

17. A method of operating a file system on a portable computing device, comprising:
receiving a file on the portable computing device;
receiving an indication from a user of the portable computing device that the file is to be used later, and responsive to receiving said indication, characterizing the file according to characterized information about the file; and storing the file along with the characterized information about the file as a stored file;
wherein there are multiple stored files;
determining that the user is at a first location, and receiving from the user information about which of the stored files is relevant to the first location;
using the information about which of the stored files is relevant to the first location as global information, and providing the global information to other users who are at the first location and cannot identify a desired file at the first location.

18. The method as in claim 17, wherein the file represents a claim check, for a business operating at the first location, the global information represents at least one claim check that was identified at the location by the user.

19. The method as in claim 18, further comprising, on the other users device, finding a stored file which looks like the claim check stored by the user.
